(19) United States
(12) Patent Application Publication
(10) Pub. No.: US 2019/0268223 A1
(43) Pub. Date: Aug. 29, 2019

(54) FIELD DEVICE FOR AN AUTOMATION SYSTEM

(71) Applicant: Siemens Aktiengesellschaft, Munchen (DE)

(72) Inventors: Matthias Meier, Poppenricht (DE); Klaus Behringer, Igensdorf (DE)

(21) Appl. No.: 16/286,547

(22) Filed: Feb. 26, 2019

(30) Foreign Application Priority Data
Feb. 27, 2018 (EP) 18158857.5

(51) Int. Cl. H04L 12/24; H04L 29/06; H04L 29/08

(52) U.S. Cl. CPC H04L 41/0813; H04L 67/02; H04L 63/102

(57) ABSTRACT

A field device for an automation system includes an arithmetic unit configured to manage configuration data for operating the field device. The field device also includes an operating element that may be actuated by a user. Actuation of the operating element may be detected by the arithmetic unit. The field device includes a hardware interface to enable the field device to be connected to a communication system of the automation system or a configuration unit. The arithmetic unit is configured to put the field device into a configuration mode to change the configuration data if simultaneously a first signal from the operating element, which represents an actuation by a user, and a second signal from the hardware interface, which represents a terminal connection of a wired connection, are received.

This application claims the benefit of EP 18158857.5, filed on Feb. 27, 2018, which is hereby incorporated by reference in its entirety.

### BACKGROUND

The present embodiments relate to a field device for an automation system.

A field device is a technical device in the field of automation technology. The field device is used, for example, for controlling and/or monitoring and/or protecting a component in a production process or a work process. Via a hardware interface of the field device, the field device is connected to a control and management system either via a field bus or increasingly also via a realtime Ethernet as a communication system. Data that is used to regulate, control, and further process the field device or the associated component is evaluated in the control and management system.

Since not all field devices have a sufficiently large display, the configuration is performed via an external configuration unit that may access the display via the communication system and the hardware interface of the field device.

If the hardware interface is configured to connect the field device to a field bus system, the hardware interface has merely restricted, local communication facilities. For on-site configuration of the field device, a Profinet connection (or another serial data connection supported by the field bus) is to be set up by an engineer, for which special software tools are to be provided. These software tools may in this case differ from field device to field device, providing that such a configuration is inflexible. Alternatively, a programmable control system may be used, although this likewise entails a considerable amount of effort.

If the hardware interface is provided for connection to the realtime Ethernet communication system, then extended, since standardized, communication with the field device is possible. The embodiment of the hardware interface as an Ethernet interface does, however, entail an increased potential risk of attacks. If, for example, an attacker gains access to the Ethernet-based communication system of the automation system, the attacker may readily access the arithmetic unit of the field device in the absence of further protection mechanisms and, if appropriate, delete and/or change configuration data for the operation of the field device, so that in the worst-case scenario the field device may no longer be operated as intended.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, a field device for an automation system and a method for computer-aided configuration of a field device for an automation system, which provide simple on-site configuration at the same time as a high level of security against unauthorized access, are provided.

According to a first aspect, a field device for an automation system that includes an arithmetic unit, an operating unit that may be actuated by a user, and a hardware interface is provided. The arithmetic unit (e.g., formed by one or more processors) is configured to manage configuration data for operating the field device. An actuation of the operating element by a user may be detected by the arithmetic unit. The hardware interface is used to connect the field device to a communication system of the automation system or a configuration unit.

The arithmetic unit is configured to put the field device into a configuration mode to change the configuration data if, simultaneously, a first signal from the operating element that represents an actuation by the user and a second signal from the hardware interface that represents the terminal connection of a wired connection are received.

A field device configured in this way enables the integration of a special on-site mode, which enables the configuration data for operation of the field device by a user to be changed only at the location of the field device. In this case, the arithmetic unit does not enable the configuration data to be changed unless two conditions are satisfied at the same point in time. Firstly, the actuation of the operating element by a user is to be provided. Secondly, the signaling of the terminal connection of a wired connection is to be provided. By this is provided the process of connecting a cable to the hardware interface. Both criteria provide that the user performs both actions at the location of the field device in order to enable the arithmetic unit to check these as criteria. It is therefore possible to access or change the configuration data only if the user has physical access to the field device. Regardless of the configuration of the hardware interface and/or of the communication system and respective protection mechanisms, a high level of security against manipulation may be provided thereby.

This enables the field device to be configured such that the arithmetic unit executes a web server, by which the configuration data may be changed. In this way, it is possible to dispense with special software tools to change the configuration data, since the web server may provide a user who, for example, may communicate via the hardware interface with the arithmetic unit of the field device, with all data, input masks, etc. that are provided for the configuration via a configuration unit in the form of a computer or tablet PC. The field device does not therefore need to have a proprietary display to change the configuration data. The execution of the web server may be initiated in that the field device connected to the configuration unit via a wired connection that is plugged into the hardware interface will simultaneously actuate the operating element. Thanks to both these criteria, the field device is then put into configuration mode, which allows the configuration data to be changed.

According to a further embodiment, the arithmetic unit may be configured to permit the configuration data to be changed (e.g., written) in the configuration mode.

To enable even greater security against unauthorized access to the configuration data of the field device, the arithmetic unit may be configured to request a password in configuration mode before allowing a change. Besides the physical presence of the user configuring the field device, who is to simultaneously actuate the operating element of the field device and connect a wired connection to the hardware interface, a password is therefore to be entered by the user as a further criterion in order to make a change to the configuration data of the field device with the help of the web server executed by the arithmetic unit of the field device.

According to a further embodiment, it may be provided that the web server may be accessed by the configuration unit via a defined (e.g., permanent) address. To access the web server, the address of the web server is therefore to be known to the user. Alternatively, the web server may be accessible by the configuration unit via a dynamic assignment of a network configuration with name resolution. This principle is known as dynamic host configuration protocol (DHCP). Likewise, an “alias” may also be implemented, so that the user is merely to specify a name known to the user (e.g., “ABCdevice”) in the web server in the address line.

The first signal may include defined content information and/or be present for a defined period of time. Defined content information may, for example, be used if the field device has a plurality of operating elements, where the actuation of a respective operating element represents a different item of information. If the field device only has one operating element or if a particular operating element is to be actuated to activate the configuration mode, this may be implemented by actuation for a defined minimum duration, for example.

According to a further embodiment, the second signal results from the wired connection being plugged into the hardware interface. In this case, known mechanisms for identifying respective plug-in components and the associated signaling protocols may be used.

For example, the hardware interface is an Ethernet interface that is based on the IP protocol.

According to a further embodiment, it is provided that the arithmetic unit is configured to terminate the configuration mode automatically after a defined period of time. As a result, the possibility of making changes to the configuration data is limited in terms of time, where the period of time is dimensioned such that all activities required to carry out or change a configuration may be securely concluded. Thanks to the automatic termination of the configuration mode after a defined period of time, it is not necessary for the user to explicitly log off from the web server or close the web server. Security against unauthorized access to the field device is hereby increased.

According to a second aspect, a method for the computer-aided configuration of a field device is provided, where the field device is configured in the manner described above and described below. The method includes the act of receiving a first signal from the actuation element, which represents an actuation by a user. The method includes the further act of receiving a second signal from the hardware interface that represents the terminal connection of a wired connection. The method includes the act of putting the field device into a configuration mode, in which the configuration data of the field device may be changed by a configuration unit if the first signal and the second signal are received simultaneously.

The method described has the same advantages as those described above in connection with the field device.

According to an embodiment of the method, the arithmetic unit executes a web server in the configuration mode. The web server is started automatically if the arithmetic unit establishes that the first signal and the second signal have been received simultaneously.

In the configuration mode, the arithmetic unit permits the configuration data to be changed (e.g., written). The configuration data is written or changed expediently with the help of an external configuration unit, which is connected to the field device via the wired connection and the hardware interface. The configuration unit may be a computer (e.g., a laptop, a tablet PC, etc.).

The web server is expediently accessed by the configuration unit via a defined (e.g., permanent) address. The address of the web server is in this case to be known to the user. Alternatively, the web server may be accessed by the configuration unit via a dynamic assignment of a network configuration and name resolution. Thus, a network address may be automatically assigned using the known DHCP method. Likewise, an “alias” may be implemented, so that the user undertaking the configuration merely has to input an alias name known to the (e.g., “ABCdevice”) in the address field of the web server.

According to a further embodiment, the arithmetic unit determines whether the first signal contains defined content information or is present for a defined period of time. Only if a respective criterion exists does the first signal then represent an actuation by a user.

According to a further embodiment, the arithmetic unit determines whether the second signal results from the wired connection being plugged into the hardware interface. Only in this case does the second signal represent the terminal connection of a wired connection and thus results in the criterion being satisfied.

A further embodiment provides that the arithmetic unit automatically terminates the configuration mode after a defined period of time. This provides that in the event of the configuration unit being connected to the field device for a continuous period of time, no subsequent change, which possibly does not originate from an authorized user, may be made to the configuration data.

A computer program containing software code sections for the performance of the aforementioned acts is further provided.

In addition, a computer program product that may be loaded directly into the internal memory of a digital arithmetic unit and includes software code sections (e.g., instructions) with which the method described herein may be executed if the product is running on the arithmetic unit is provided. The computer program product may take the form of a non-transitory computer-readable storage medium (e.g., CD-ROM, a DVD, a USB memory stick) or a signal that may be loaded via a wired or wireless network.

### BRIEF DESCRIPTION OF THE DRAWINGS

FIG. 1 shows a schematic representation of one embodiment of a field device for an automation system, which for configuration, is coupled to a configuration unit for the exchange of data; and

FIG. 2 shows a flow chart that illustrates the acts of one embodiment of a method.

### DETAILED DESCRIPTION

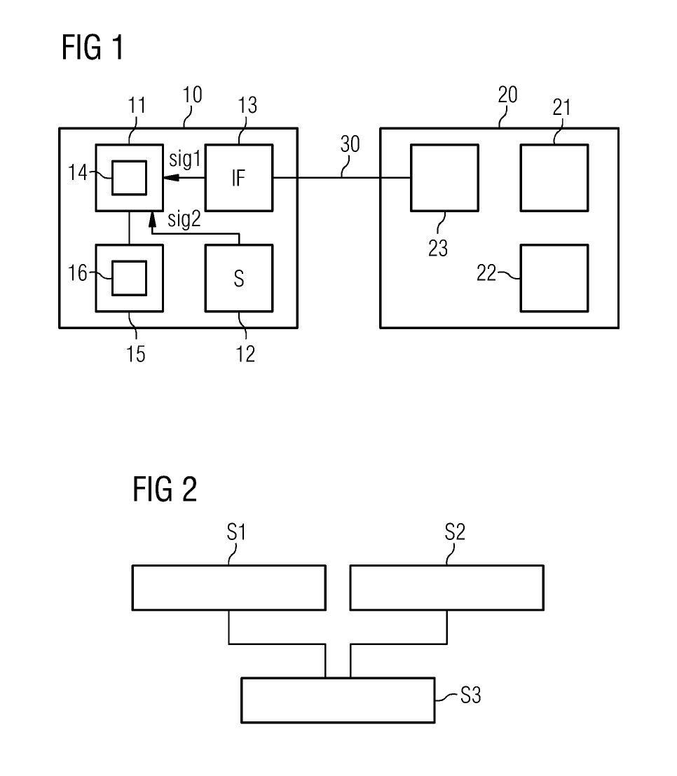

FIG. 1 shows one embodiment of a field device 10 for an automation system.

The field device 10 includes an arithmetic unit 11, an operating element 12, a hardware interface 13 and a memory 15. Configuration data 16 is stored in the memory 15 and is processed by the arithmetic unit 11 for operation of the field device 10. The field device 10 is used in a manner known to the person skilled in the art for controlling and/or monitoring a component (not shown) of the automation system.

The operating element 12 may, for example, be a button, a switch, or another element that is used for the intended operation of the field device. For example, the operating element may be a reset button to enable the field device to be put into an output state at a user's request.

The field device 10 is connected via the hardware interface 13 to a communication system (not shown) of the automation system. The communication system may, for example, be configured as a realtime Ethernet. Via the communication system, the field device 10 may, in a manner known to the person skilled in the art, exchange data (e.g., measured data, control data, etc.) with a control and management system or other field devices.

The configuration data 16 held in the memory 15 is changed with the help of a web server 14 that may be executed by the arithmetic unit 11. To be able to start the web server 14 and use the web server 14 to read or write (e.g., change) configuration data 16, two conditions are to be present that require the physical proximity of a user to the field device 10. Firstly, the operating element 12 is to be actuated by the user in a defined manner; secondly, a wired connection (e.g., a network cable) is to be connected to the hardware interface 13. Actuating the operating element 12 in the defined manner (e.g., more than 2 seconds) results in a first signal sig1 that is received by the arithmetic unit 11. Connecting a network cable to the hardware interface 13 results in a second signal sig2 that is likewise received by the interface 11. If the first signal sig1 and the second signal sig2 are received simultaneously by the arithmetic unit 11, the conditions for starting and executing the web server 14 are satisfied.

The web server 14 may, for example, be used by a configuration unit 20 in the form of a computer (e.g., laptop or tablet PC). The configuration unit 20 has a display 21, an input device 22 (e.g., keyboard and/or touch-sensitive display and/or pointing device), and an interface 23, into which the other end of the network cable 30 that represents the wired connection is plugged.

The configuration unit 20 accesses the web server 14 either via a permanent address, which is input by a user of the configuration unit 20 via the input device 22, or alternatively, an address may be dynamically assigned via DHCP, as soon as the physical connection is established with the help of the wired connection 30 between the hardware interface 13 and the interface 23. Access to the web server is however, as described above, enabled only if the arithmetic unit 11 has simultaneously been able to establish the actuation of the operating element 12 by the user. For this purpose, it may be necessary, as described, for the operating element 12 to be depressed for a defined period of time (e.g., several seconds).

As soon as the web server is activated, the configuration data 16 may be changed by the configuration unit 20. The configuration data that is currently stored in the memory 15 may for this purpose initially be visualized on the display 21 and changed, overwritten, or deleted with the help of the input device 22.

To increase security, provision may also be made for a password to be requested from the user after the web server is started via the configuration unit.

It is further expedient if the access to the web server 14 is restricted in terms of time. Thus, the web server 14 may be automatically stopped by the arithmetic unit 11 if, for example, a defined period of time (e.g., 10 minutes) has elapsed after the web server was started. This makes it more difficult for potential attackers to manipulate the configuration data 16 in the field device 10.

To make the change to the configuration data 16, as described, the connection, provided during operation, of the hardware interface 13 to the communication system is disconnected, and instead, a direct connection using a wired connection 30 (e.g., network cable) to the configuration unit 20 is made. On conclusion of the configuration, the wired connection 30 is disconnected from the hardware interface 13, and a connection is made to the communication system.

Instead of making a direct connection between the field device 10 and the configuration unit 20, as illustrated in FIG. 1, both components may also be connected to one another by the interposition of a router or other technical switching device.

FIG. 2 shows the basic sequence of the method for the computer-aided configuration of the field device 10. In a first act S1, a first signal sig1 from the operating element 12 is received, which represents an actuation by a user. In act S2, a second signal sig2 from the hardware interface 13 is received, which represents the terminal connection of a wired connection. If it is established in act S3 that the first signal sig1 and the second signal sig1 are received simultaneously by the arithmetic unit 11, the field device 10 is transferred by the arithmetic unit 11 into a configuration mode in which the configuration data 16 of the field device 10 may be changed by a configuration unit 20 connected to the hardware interface 13.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A field device for an automation system, the field device comprising:
an arithmetic unit configured to manage configuration data for operating the field device;
an operating element that is actuable by a user, an actuation of the operating element being detectable by the arithmetic unit; and
a hardware interface configured to enable the field device to be connected to a communication system of the automation system or a configuration unit,
wherein the arithmetic unit is further configured to put the field device into a configuration mode to change the configuration data when, simultaneously, a first signal from the operating element, which represents the actuation by the user, and a second signal from the hardware interface, which represents a terminal connection of a wired connection, are received.

2. The field device of claim 1, wherein the arithmetic unit is configured to execute a web server in the configuration mode.

3. The field device of claim 1, wherein the arithmetic unit is configured to permit the configuration data to be changed in the configuration mode.

4. The field device of claim 3, wherein the arithmetic unit is configured to permit the configuration data to be written in the configuration mode.

5. The field device of claim 3, wherein the arithmetic unit is configured to request a password before a change is permitted in the configuration mode.

6. The field device of claim 2, wherein the web server is accessible by the configuration unit via a defined address.

7. The field device of claim 2, wherein the web server is accessible by the configuration unit via a dynamic assignment of a network configuration and name resolution.

8. The field device of claim 1, wherein the first signal comprises defined content information, is present for a defined period of time, or the first signal comprises defined content information and is present for the defined period of time.

9. The field device of claim 1, wherein the second signal results from the wired connection being plugged into the hardware interface.

10. The field device of claim 1, wherein the arithmetic unit is configured to terminate the configuration mode automatically after a defined period of time.

11. The field device of claim 1, wherein the hardware interface is an Ethernet interface based on the IP protocol.

12. A method for a computer-aided configuration of a field device, wherein the field device comprises an arithmetic unit configured to manage configuration data for operating the field device, an operating element that is actuable by a user, an actuation of the operating element being detectable by the arithmetic unit, and a hardware interface configured to enable the field device to be connected to a communication system of the automation system or a configuration unit, the method comprising:
receiving a first signal from the operating element, the first signal representing an actuation by a user;
receiving a second signal from the hardware interface, the second signal representing a terminal connection of a wired connection; and
placing the field device in a configuration mode, in which the configuration data of the field device is changeable by the configuration unit when the first signal and the second signal are received simultaneously.

13. The method of claim 12, wherein the arithmetic unit executes a web server in the configuration mode.

14. The method of claim 12, wherein the arithmetic unit permits the configuration data to be changed in the configuration mode.

15. The method of claim 14, wherein the arithmetic unit permits the configuration data to be written in the configuration mode.

16. The method of claim 13, wherein the web server is accessed by the configuration unit via a defined address.

17. The method of claim 13, wherein the web server is accessed by the configuration unit via a dynamic assignment of a network configuration and name resolution.

18. The method of claim 12, further comprising determining, by the arithmetic unit, whether the first signal comprises defined content information or is present for a defined period of time.

19. The method of claim 12, further comprising determining, by the arithmetic unit, whether the second signal results for the wired connection being plugged into the hardware interface.

20. The method of claim 12, further comprising automatically terminating, by the arithmetic unit, the configuration mode after a defined period of time.

21. In a non-transitory computer-readable storage medium that stores instructions executable by a digital arithmetic unit for a computer-aided configuration of a field device, wherein the field device comprises an arithmetic unit configured to manage configuration data for operating the field device, an operating element that is actuable by a user, an actuation of the operating element being detectable by the arithmetic unit, and a hardware interface configured to enable the field device to be connected to a communication system of the automation system or a configuration unit, the instructions comprising:
receiving a first signal from the operating element, the first signal representing an actuation by a user;
receiving a second signal from the hardware interface, the second signal representing a terminal connection of a wired connection; and
placing the field device in a configuration mode, in which the configuration data of the field device is changeable by the configuration unit when the first signal and the second signal are received simultaneously.
